(19) United States
(12) Patent Application Publication
(10) Pub. No.: US 2014/0188729 A1
(43) Pub. Date: Jul. 3, 2014

(54) REMOTE NOTIFICATION AND ACTION SYSTEM WITH EVENT GENERATING

(71) Applicant: Jiang Hong, San Jose, CA (US)

(72) Inventor: Jiang Hong, San Jose, CA (US)

(73) Assignee: Ricoh Company, Ltd., Tokyo (JP)

(21) Appl. No.: 13/733,121

(22) Filed: Jan. 2, 2013

(51) Int. Cl. H04L 12/26

(52) U.S. Cl. CPC H04L 43/10
USPC 705/44; 709/224

(57) ABSTRACT

A method for managing event communications and actions is presented. The method comprises receiving and storing data representing a plurality of event categories for a plurality of events detectable on a plurality of electronic devices and receiving, from a particular electronic device, event data associated with a particular event occurring at the particular electronic device. Based, at least in part, on the event data and a plurality of event categories, for the particular event, a particular event category, from the plurality of event categories is determined. Based, at least in part, on the particular event category, one or more recipients and one or more actions associated with the particular event category are determined. For each recipient, if a preferred communications method with the recipient is specified, then a communication, specifying the particular event and the one or more actions, is transmitted to the recipient according to the preferred communications method.

### RELATED APPLICATIONS

This application is related to U.S. patent application Ser. No. 13/540,231 (Attorney Docket No. 49986-0750) titled “Remote Notification And Action System,” filed Jul. 2, 2012, the contents of which are incorporated by reference in their entirety for all purposes as if fully set forth herein.

### FIELD OF THE INVENTION

Embodiments relate generally to managing events and actions, and more specifically, to an approach for remote event detection, notification and handling.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Electronic devices periodically malfunction and need to be serviced. Servicing electronic devices usually refers to maintaining an operational state of the devices. For example, servicing a printing device may include testing an ink level in the device and replenishing the ink if needed.

In some cases, detecting operational problems in devices may be difficult. For example, some devices do not generate error messages when they malfunction; other devices generate messages, but they display the messages only on the devices' displays. These messages may be easily overlooked, especially if the displays are not continuously monitored.

Even if an error message indicating a problem in a device is noticed, determining whether the error message indicates a critical or non-critical event may be difficult. Furthermore, it may be difficult to determine the type of remedial action for addressing the problem. For example, in a large network of electronic devices, some of which are malfunctioning, determining the components that may be repaired and the components that need to be replaced may be quite challenging.

### SUMMARY

An approach is provided for detecting events occurring in devices, transmitting event communications to recipients and managing remedial actions indicated by the recipients. A method comprises receiving and storing data representing a plurality of event categories for a plurality of events detectable on a plurality of electronic devices. The data representing an event category, from the plurality of event categories, comprises a category description, information indicating one or more recipients and a description of one or more actions. When a particular event occurs on a particular electronic device, event data associated with the particular event is received from the particular device. Based, at least in part, on the event data and the plurality of event categories, a particular event category, from the plurality of event categories, is determined for the particular event. Based, at least in part, on the particular event category, one or more recipients of an event communication are determined. Further, an indication whether one or more actions are associated with the particular event category is determined. In response to determining the one or more actions, the event communication is transmitted to a recipient according to the recipient's preferred communications method if such a method is specified. Alternatively, the event communication is transmitted to a recipient according to a default communications method. The event communication specifies the particular event and the one or more actions.

### BRIEF DESCRIPTION OF THE DRAWINGS

In the figures of the accompanying drawings like reference numerals refer to similar elements.

FIG. 1 is a block diagram that depicts an example of a remote event detection, notification and action system.

FIG. 2 is a block diagram that depicts an example of a remote event detection, notification and action system.

FIG. 3A is a flow diagram that depicts an approach for detecting an event and generating event data.

FIG. 3B is a flow diagram that depicts an approach for processing event data and generating event communications.

FIG. 3C is a flow diagram that depicts an approach for processing a remote action.

FIG. 4 is a flow diagram that depicts an approach for dispatching event communications.

FIG. 5 is a flow diagram that depicts an approach for generating a response to an event communication.

FIG. 6 is a flow diagram that depicts an approach for processing a response.

FIG. 7 is a flow diagram that depicts an approach for defining a communications method for a user.

FIG. 8 is a block diagram that depicts an example computer system upon which embodiments may be implemented.

### DETAILED DESCRIPTION

In the following description, for the purposes of explanation, numerous specific details are set forth in order to provide a thorough understanding of the embodiments. It will be apparent, however, to one skilled in the art that the embodiments may be practiced without these specific details. In other instances, well-known structures and devices are shown in block diagram form in order to avoid unnecessarily obscuring the embodiments.
I. OVERVIEW
II. SYSTEM ARCHITECTURE
III. EVENT DETECTION, EVENT DATA COMMUNICATION AND ACTION PROCESSING
   A. Introduction
   B. Event Detection
   C. Event Processing
   D. Dispatching Event Communications
   E. Generating Responses to Event Communications
   F. Response Processing
   G. Determining Communications Methods
IV. IMPLEMENTATION MECHANISMS

### I. Overview

An approach is provided for detecting events, notifying users about the events and performing remedial actions indicated by the users. According to the approach, data representing a plurality of event categories for events detectable on a plurality of electronic devices is received and stored. Examples of the event categories include, without limitation, an error, a warning, a maintenance request, and a power failure. The data representing an event category comprises a category description, information indicating one or more recipients and a description of one or more actions.

From a particular electronic device from the plurality of electronic devices, event data is received. The event data is associated with a particular event occurring at the particular electronic device. Examples of events include, without limitation, an occurrence of a customer-defined error, an occurrence of a vendor-defined warning, an occurrence of a system warning, and a power failure. Based, at least in part, on the event data, a particular event category from the plurality of event categories is determined for the particular event. Based, at least in part, on the particular event category, one or more recipients are determined. Further, based, at least in part, on the particular event category, one or more actions recommendable to the recipients and associated with the particular event category are determined.

In response to determining that the one or more actions are associated with the particular event category, for each recipient, a determination is made whether a preferred communications method with the recipient is specified. If so, then a communication is generated and transmitted to the recipient according to the preferred communications method. The communication specifies the particular event and the one or more actions. In response to transmitting the communication to the recipient, user data is received. The user data indicates a user selection of a particular action, from the one or more actions. The particular action may be either performed directly on the particular device, or by a remote entity, such as a service provider or a device manufacturer. If the particular action is to be performed by the remote entity, the system determines whether the particular action may be provided free of charge, and if not, whether the recipient has approved an automatic payment for the service. Depending on the outcome, either a service request based on the particular action is generated and sent to the remote entity, or payment information is requested from the recipient.

### II. System Architecture

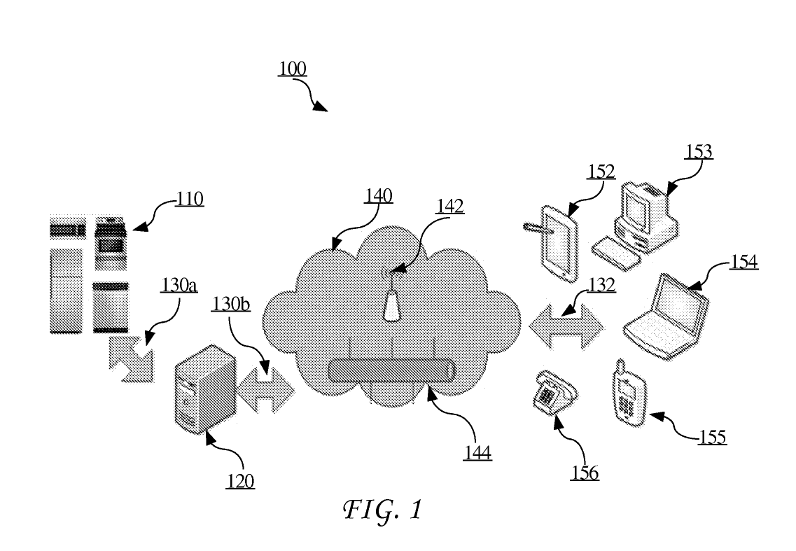

FIG. 1 is a block diagram that depicts an example of a remote event detection, notification and action system 100. A system 100 comprises one or more electronic devices 110, a plurality of communications links 130 and 132, one or more networks 140, and one or more user devices 152, 153, 154, 155 and 156. Optionally, system 100 may also include one or more computer servers 120.

The approaches described herein are not limited to any particular type of electronic devices 110. Example electronic devices 110 include, without limitation, computers, computer peripheral devices (such as MFP devices, fax machines, copy machines, scanners and plotters), tablets, personal digital assistants, household appliances (such as microwaves, refrigerators, cooking ranges, dishwashers, washing machines and dryers), industrial appliances (such as elevators and escalators), and automobiles.

An electronic device 110 may be configured to detect various events. An event may indicate a success in performing a task, a failure in completing a task, a result of completing a task, a device status, an error, a warning, a summary of various activities taking places on a device, and any other events taking place on the device. For example, an event may be an indication of a successfully performed task on the device, or that a problem occurred in performing the task. According to another example, if an electronic device 110 is a refrigerator, and a thermostat in the refrigerator 110 has stopped working, then the refrigerator 110 may generate an event indicating that the thermostat is malfunctioning.

An electronic device 110 may be configured to detect various events using a variety of sensors. The sensors may be communicatively coupled with components of electronic device 110, and may be interfaced with software applications executed on the device. The sensors may be configured to gather information about an operational status of the device and a state of components of the device.

An electronic device 110 may be configured to process information about events, generate event data comprising the event information and send the event data via one or more networks 140 and links 132 to one or more user devices 152-156. Alternatively, electronic device 110 may be configured to transmit the event information to a server 120 (described below), and cause server 120 to generate the event data from the event information, and transmit the event data to one or more user devices 152-156 via one or more communications links 130b, one or more networks 140 and one or more communications links 132. Electronic device 110 may also transmit the event information to data storage, from which server 120 may retrieve the event information.

An electronic device 110 may also be configured to receive responses from user devices 152-156 (described below). For example, upon transmitting, to a user device 152, event data indicating a particular event, the user may review the received event data, prepare a response, and send the response to electronic device 110, or to server 120. The user may send the response via one or more communications links 132, one or more networks 140, and one or more links 130. A response may indicate one or more remedial actions to be performed with respect to electronic device 110 to address the event occurring on electronic device 110. For example, if electronic device 110 is a refrigerator on which a thermostat malfunctions, electronic device 110 may detect the thermostat malfunctioning as an event and communicate the event to a user device 152; then electronic device 110 may receive a response from user device 152 indicating that a vendor who services the refrigerator 110 may be contacted to replace the thermostat on electronic device 110. The responses may be interpreted by electronic device 110, or may be sent to server 120, and interpreted by server 120.

An electronic device 110 may be configured to communicate with one or more servers 120. If an electronic device 110 is configured to communicate with user devices 152-156 directly, then server 120 may be optional. However, if electronic device 110 is not configured to communicate with user devices 152-156 directly, then one or more servers 120 may be deployed in system 100 to support the functionality of system 100.

An electronic device 110 may be configured to send event information to server 120 to indicate that one or more events have occurred at electronic device 110. In some implementations, electronic device 110 may “push” the event information to server 120 each time an event occurs at electronic device 110. In other implementations, electronic device 110 may store the event information in data buffers maintained by electronic device 110, and rely on other applications, such as daemon processes, to access the buffers of electronic device 110, retrieve the stored event information and communicate the event information to server 120.

Electronic device 110 may also receive information from server 120. For example, electronic device 110 may receive commands or instructions to be performed on electronic device 110. Examples of the command and instructions may include a request to restart electronic device 110, turn off electronic device 110, or reconfigure electronic device 110.

A server 120 may be configured to process event information received from electronic device 110. For example, server 120 may be configured to receive event information from electronic device 110. The event information may indicate that an event was detected on electronic device 110. Server 120 may also be configured to generate event data from the received event information, determine whether any remedial action may be recommended to address the detected event, determine whether to communicate the event data (and remedial actions) to any user, and, if needed, transmit the event data and the recommended actions to one or more user devices 152-156. Server 120 may also be configured to receive the event information from electronic device 110 via one or more links 130a, and communicate the event data to user devices 152-156 via one or more links 130b, one or more networks 140 and one or more links 132.

A server 120 may also be configured to receive responses to event data from users. For example, server 120 may be configured to receive indications of one or more remedial actions to be performed with respect to electronic device 110, on which an event was detected and communicated to a user. Server 120 may be further configured to process the response, identify one or more remedial actions indicated in the response, and initiate execution of the remedial actions. For example, if a response comprises information indicating one or more remedial actions to be performed on electronic device 110, then server 120 may identify the remedial actions in the response, translate each of the remedial actions into one or more commands (or instructions), and transmit the commands/instructions to electronic device 110 to cause an execution of the commands/instructions on electronic device 110. According to another example, if a response comprises information indicating a request to contact a particular vendor who services electronic device 120, then server 120 may generate a service request and transmit the service request to the particular vendor.

Communications links 130a, 130b and 132 may be any type of communications link, a tunnel or any type of a connection configured to receive and transmit data.

Network 140 may be any type of data communications network configured to transmit data. For example, network 140 may be a local area network (LAN), a wide area network (WAN), an Ethernet network, a service provider network, a wireless network with one or more communications towers 142, or any type of network known in the industry.

In network 140, one or more communications channels 144 may be established and used to communicate data between electronic device 110, server 120, and user devices 152-156.

User devices 152-156 are configured to communicate directly or indirectly with electronic device 110 and server 120, if server 120 is part of system 100. User devices 152-156 may be client devices, user devices, system administrator devices, management devices or any other types of devices configured to receive notifications from other devices. Non-limiting examples of user devices 152-156 include a tablet 152, a personal computer 153, a laptop 154, a smartphone 155, and a telephone 156. Although not depicted in FIG. 1, user devices 152-156 may also comprise computer servers, PDAs, and any other device configured to receive, process and transmit data.

User devices 152-156 may be configured to receive event communications from electronic device 110 (or server 120), process the communications, generate a response from the communications, and transmit the response to electronic device 110 (or server 120). For example, upon receiving an event communication at a tablet 152, an application executed on tablet 152 may cause displaying the event notification on the tablet display, display one or more remedial actions suggested to the user, and wait for input from a user. Once the user selects one of the suggested remedial actions, and enters his selection via a tabled input device, a tablet application may generate a response based on the user input, and communicate the response to either electronic device 110 or server 120. According to another example, upon receiving a text message, comprising an event communication, on a smartphone 155, an application executed on smartphone 155 may cause displaying the text message on the smartphone display, and wait for the user input. Once the user enters a text message, specifying one or more remedial actions to be performed on electronic device 110, a smartphone application may generate a response based on the user's text message, and communicate the response to either electronic device 110 or server 120. According to other example, an event communication may be sent to telephone 156 as a telephone call. Upon receiving a phone call, comprising an event communication, a user may accept the call, listen to the prerecorded message and a telephonic menu, and determine whether any of the menu options may select an action for remedying the event detected on electronic device 110. Once the user makes a selection, the selection may be sent to electronic device 110 or server 120. The selection may indicate a particular remedial action to be performed with respect to electronic device 110.

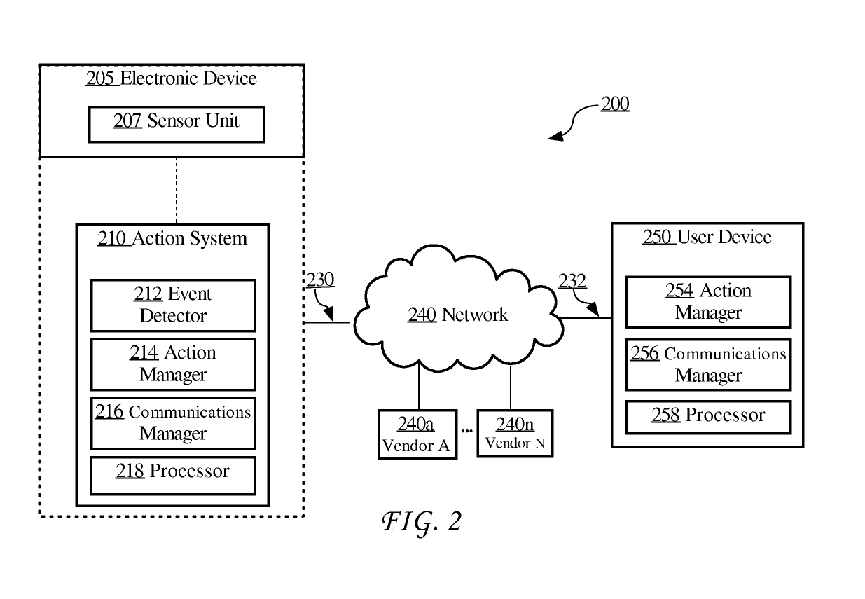

FIG. 2 is a block diagram that depicts an example of a remote event detection, notification and action system 200. An example system 200 comprises an electronic device 205, communications links 230 and 232, a network 240, and a user device 250. Optionally, vendor devices 240a-240n may be communicatively coupled to network 240. In an embodiment, electronic device 205 corresponds to electronic device 110 of FIG. 1, communications links 230 and 232 correspond to respective communications links 130 and 132 of FIG. 1, network 240 corresponds to network 140 of FIG. 1, and user device 250 corresponds to any of user devices 152-156 of FIG. 1.

In an embodiment, electronic device 205 comprises one or more components. In the example depicted in FIG. 2, electronic device 205 comprises one or more sensor units 207 and one or more action systems 210. In some implementation, action system 210 may be physically implemented within electronic device 205, as it is depicted in FIG. 2. In some other implementations, action system 210 may be implemented in server 120, not depicted in FIG. 2.

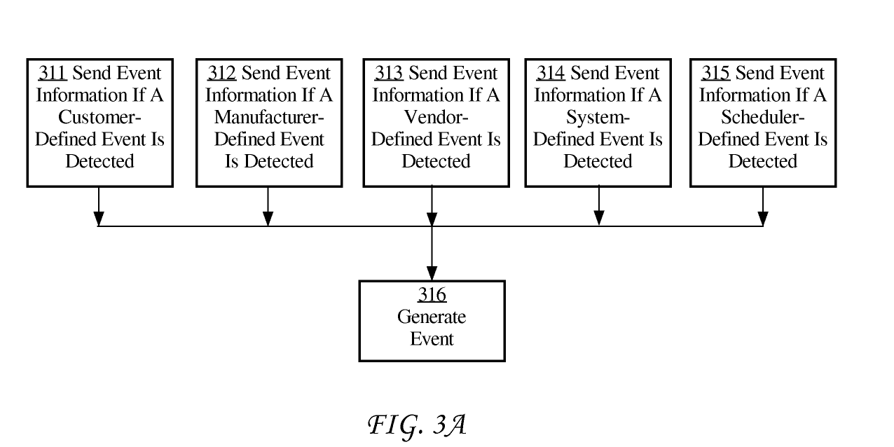

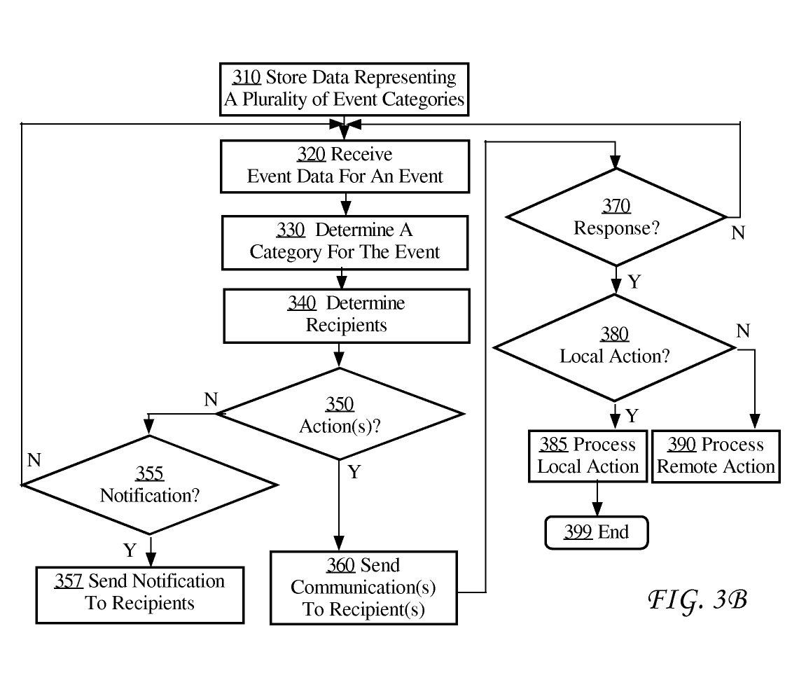

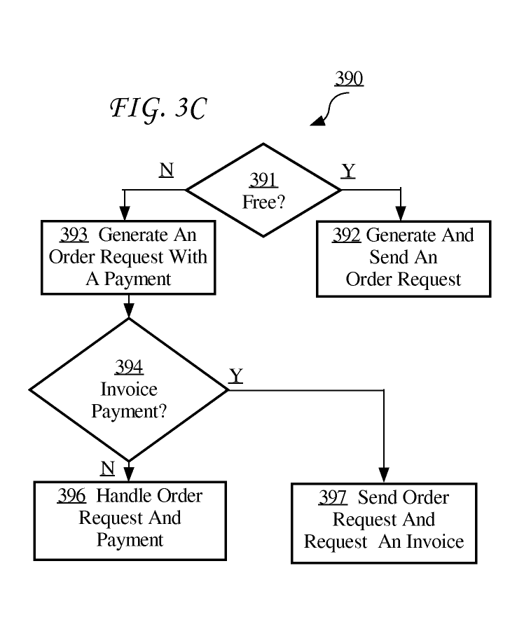

A sensor unit 207 may be configured to collect event information from one or more sensors installed in electronic device 205. Sensor unit 207 may comprise a software application configured to interface with mechanical and electronic sensors installed in electronic device 205, collect information about detected events, interpret the collected information and communicate the interpreted information to action system 210. Various approaches for collecting information from the sensors are described in FIG. 3B, below.

In cooperation with sensors installed in electronic device 205, sensor unit 207 may monitor execution of various applications on electronic device 205, monitor operational status of electronic device 205 and its components, and intercept events indicating problems occurring on electronic device 205. For example, if electronic device 205 is a MFP device, and one of the sensors detected a paper-jam on the device, then, upon receiving an indication of the paper-jam from the sensor, sensor unit 207 may generate a paper-jam event for electronic device 205, and communicate the event information to an action system 210.

An action system 210 may be implemented as a component of electronic device 205, as it is depicted in FIG. 2. Alternatively, an action system 210 may be implemented in a server (not depicted in FIG. 2), which may be communicatively coupled with electronic device 205.

In an embodiment, action system 210 comprises various components, including an event detector 212, an action manager 214, a communications manager 216 and one or more processors 218. Some embodiments of action system 210 may comprise all components 212, 214, 216 and 218; other embodiments of action system 210 may comprise other components in addition to components 212, 214, 216 and 218; yet other embodiments of action system 210 may comprise some, but not all, components 212, 214, 216 and 218. EAB Note: with some Examiners the use of the term “module” will be confusing or possibly provoke an objection or rejection, so the term “component” is a good substitute

An event detector 212 may be configured to receive information about detected events occurring on electronic device 205. For example, event detector 212 may receive event information provided by sensor unit 207, described above. Event detector 212 may also be configured to use the received event information to generate an event communication, and transmit the communication to an action manager 214.

An action manager 214 may be configured to receive an event communication, process the communication, and determine actions to remedy the event. For example, for a particular event, action manager 214 may determine whether to perform any remedial action on electronic device 205, and if so, the type of the remedial action that may be recommended.

An action manager 214 may also be configured to determine whether to transmit an event communication to any users. The determination may depend on the category of the detected event. A category of the detected event may be determined based on characteristics of the events. Event categories may be defined in advance and stored in a storage device. The event categories may be modified by users, vendors and manufacturers as need.

While some events may be non-critical and need not be communicated to users, other events may be critical and may be sent to the users. For example, some events that merely confirm an operational status of electronic device 205 may be ignored. In fact, in the interest of limiting needless data traffic from and to electronic device 205, information about such events need not be communicated to the users. However, other events that indicate that electronic device 205 became inoperative may be considered as critical. In the interest of restoring operability of electronic device 205, information about such events may be communicated to the users, hoping that the problem may be solved.

An action manager 214 may also be configured to determine who may be contacted when an event is detected in electronic device 205. For example, action manager 214 may be configured to determine names of individuals who may be contacted when a particular event occurs on electronic device 205. The individuals who wished to be contacted when a particular event occurs on electronic device 205 are referred to herein as recipients.

Furthermore, action manager 214 may be configured to determine how the recipients may be contacted when an event is detected in electronic device 205. For example, action manager 214 may be configured to determine whether a particular recipient indicated a preferred communications method. If the preferred communications method has been specified, then action manager 214 may retrieve the information about the preferred communications method and indicate to for example, a communications manager 214 that the preferred method may be used when contacting the particular recipient. However, if a preferred communications method has not been specified for the particular recipient, then action manager 214 may retrieve the information about a default communications method and indicate to the communications manager 214 that the default communications method may be used when contacting the particular recipient.

An action manager 214 may further be configured to send an event communication to a communications manager 216. The event communication may comprise event data, indicate one or more recipients of the communication, and specify methods for communicating with the recipients.

Action manager 214 may also be configured to receive responses from a user device 250. The responses may be received in response to sending an event communication indicating an event detected on electronic device 205. The response may indicate one or more remedial actions to be performed on electronic device 205. Alternatively, the response may comprise a request to contact a particular vendor by sending a service order to one or more vendor devices 240a-240n. If the remedial action may be performed on electronic device 205 directly (for example, by action manager 213), then the remedial action may be referred to as a local action. However, if the remedial action indicates a need to contact a vendor, then the remedial action may be referred to as a remote action.

An action manager 214 may also be configured to parse a response received from user device 250, and determine whether the response indicates a local action or a remote action. A local action may be a remedial action that may be performed by action manager 214 directly on electronic device 205. Non-limiting examples of the local actions include restarting electronic device 205, rebooting electronic device 205, powering off electronic device 205, and deleting tasks queued on electronic device 205. A remote action may be an action that would require for example, contacting a vendor that services electronic device 205. Non-limiting examples of the remote actions include generating a service order and sending the order to a vendor, generating a part order and sending the order to a part supplier, and notifying a manufacturer of a manufacturing defect in electronic device 205.

If a response contains an indication of a local remedial action, then action manager 214 may translate the remedial action code into one or more commands that applications executed by electronic device 205 can understand, and initiate execution of the one or more commands. Execution of the commands on electronic device 205 is intended to remedy the problem detected in electronic device 205. However, if the response contains an indication of a remote remedial action, then action manager 214 may contact one or more vendors at one or more vendor devices 240a-240n, generate a service or part order, and send the order to the vendors.

In an embodiment, a communications manager 216 is configured to receive various types of information from action manager 214. For example, communication manager 216 may receive event communications, information about recipients to whom the event communications may be sent, information about preferred and default communications methods, recommended actions, and responses from the recipients.

A communications manager 216 may be configured to send an event communication to a recipient using either a preferred or default communications method. The event communication may be sent directly to user device 250. Alternatively, as it is depicted in FIG. 2, the event communication may be sent via communications link 230 to network 240, and then via link 232 to user device 250.

A communications manager 216 may also be configured to receive responses from recipients. The responses may be received directly from user device 250, or may be received via network 240, as depicted in FIG. 2. The received responses may indicate a selected remedial action that a user of user device 250 would like to have performed on electronic device 205.

In an embodiment, communications manager 216 is also configured to send the received response to action manager 214 for parsing the response into commands and executing the commands on electronic device 205.

A processor 218 is configured to process code instructions of components identified in electronic device 205. Processor 218 may implement the processes described herein using hardware logic such as in an application-specific integrated circuit (ASIC), field-programmable gate array (FPGA), system-on-a-chip (SoC) or other combinations of hardware, firmware and/or software.

A network 240 may be any type of data communications network configured to exchange data. For example, network 240 may be a local area network (LAN), a wide area network (WAN), an Ethernet network, a service provider network, or any type of a network known in the industry.

Vendor devices 240a-240n may be any type of devices configured to receive information. Vendor devices 240a-240n may be portable devices, such as smartphones, pagers, laptops and tables, or devices such as workstations, faxes and printers. Vendor devices 240a-240n may be configured to display messages, store messages or print messages. For example, vendor devices 240a-240n may be configured to receive service orders, part orders, maintenance orders, and other messages that vendors servicing electronic device 205 may find useful.

A user device 250 may be any type of computer device configured to communicate directly or indirectly with electronic device 205. User device 250 may be any type of a user device, a system administrator device, a management workstation, a vendor device or a manufacturer device. User device 250 may be configured to receive event data directly or indirectly from electronic device 205, receive user input and communicate user input to electronic device 205. Non-limiting examples of user device 250 include a mobile phone, a smartphone, a PC, a laptop, a tablet, a PDA, a personal computer, and a pager.

In an embodiment, user device 250 comprises one or more components, such as an action manager 254, a communications manager 256 and a processor 258. Embodiments may comprise each of the above components, or may comprise additional or other components, not depicted in FIG. 2.

A communications manager 256 may be configured to receive event communications. An event communication may be received directly or indirectly from electronic device 205, and may indicate an event detected in electronic device 205. Communications manager 256 may send the event communication to an action manager 254 for further processing.

In an embodiment, communications manager 256 is also configured to receive data from action manager 254 and communicate the data, directly or indirectly, to electronic device 205.

An action manager 254 may be configured to display, play, or otherwise present event communications to a user (recipient). For example, action manager 254 may be configured to display an event communications as an email on a user laptop, or to play an audio menu on a smartphone.

Furthermore, action manager 254 may be configured to receive user input, process the user input and, based on the user input, generate and send a response to electronic device 205. User input may comprise a user selection to the options displayed or played for the user. For example, if action manager 254 displayed a few recommended actions to remedy a paper-jam that occurred in a particular printer, and the user selected one of the recommended actions, then action manager 254 may receive the user selection, and communicate the user selection to communications manager 256.

Processor 258 may implement the processes described herein using hardware logic such as in an application-specific integrated circuit (ASIC), field-programmable gate array (FPGA), system-on-a-chip (SoC) or other combinations of hardware, firmware and/or software.

### III. Event Detection, Event Data Communication and Action Processing

### A. Introduction

Some aspects of the presented approach may be explained using the following example. If a user tried to print a document on a remote printer, but a paper-jam occurred on the printer, then a printer sensor may detect the paper-jam on the printer and send the printer-jam information to a printer application executed on the printer. The printer application may use the printer-jam information to generate a paper-jam event, and determine a technician who may be notified to handle the paper-jams on the printer. Further, the printer application may identify a preferred communications method for the technician. For example, the preferred communications method to contact the technician is by sending him a text message to his cellular phone.

Furthermore, the printer application may determine one or more actions for remedying the printer-jam on the printer. The printer application may also generate a communication indicating the paper-jam event, and send the communication to the technician using the preferred communications method. For example if the technician indicated that he may be reached using his cellular phone, a text message indicating the paper-jam on the particular printer may be sent to the technician's cellular phone. The communication may also indicate the one or more actions for remedying the paper-jam on the printer. For example, one of those actions may indicate that the technician needs to manually remove the paper-jam from the printer. As another example, the action may indicate that the technician may contact a field engineer to remove the paper-jam from the printer. As yet another example, the action may indicate that the technician calls a vendor technician and ask him to remove the paper-jam.

In response to sending the communication to the technician, the printer application may receive a response from the technician. For example, the technician may send a response indicating that he will contact a field engineer to remove the paper-jam from the printer.

### B. Event Detection

FIG. 3A is a flow chart that depicts an example process of detecting an event and generating event data. In FIG. 3A, elements 311-315 depict non-limiting examples of various events that may be detected by sensors and sensor applications implemented in an electronic device.

In an embodiment, an electronic device is configured to detect various events using a variety of sensors. The sensors may be communicatively coupled with components of the electronic device, and may be interfaced with software applications executed on the device. The sensors may be configured to gather information about an operational status of the device and a state of the components of the device.

Sensors may be implemented as mechanical devices, electronic devices and combinations of mechanical and electronic components. For example, sensors installed in a refrigerator may be configured to measure a temperature in various compartments of the refrigerator and communicate the temperature information to the sensor central unit. According to another example, sensors installed in a MFP device may be configured to test a level of ink in an ink cartridge and communicate the level information to the sensor unit.

Sensors may be programmed by specialized applications encoded in electronic circuits or chips and installed in an electronic device. A specialized application may be developed and provided by customers, manufacturers, vendors, system administrators and other application developers. The customers, manufactures and others may define various types of information that may be collected from the sensors, the type of processing of the collected information and the method of handling the processed information. For example, a refrigerator may execute a customized software application to test a temperature in various compartments of the refrigerator, collect the temperature measurements, determine whether certain temperature thresholds are exceeded, determine the circumstances in which the temperature thresholds are exceeded (which may indicate a problem) and determine the circumstances in which the temperature thresholds are not exceeded (which may indicate that the refrigerator functions properly). The information indicating whether any problems occurred, whether the electronic device functions properly, whether any errors have been detected and any other information are referred herein as event information.

Information collected from the sensors may be transmitted to a sensor unit of an electronic device or to a server. A sensor unit may be configured to collect event information from one or more sensors installed in an electronic device. A sensor unit may comprise a software application configured to interface with mechanical and electronic sensors, collect information about detected events, interpret the collected information and communicate the interpreted information to an action system of the electronic device.

In cooperation with various sensors installed in an electronic device, a sensor unit may monitor execution of various applications on the electronic device, monitor operational status of the electronic device and its components, and intercept events indicating problems occurring on the electronic device. For example, if an electronic device is a MFP device, and one of the sensors detected a paper-jam on the device, then, upon receiving an indication of the paper-jam from the sensor, a sensor unit may interpret the received indication as detecting an event on the electronic device, and communicate the event information to an action system of the device.

Non-limiting examples of various events are depicted in FIG. 3A. For example, if a customer-defined error is detected on a device, then event information 311, indicating a customer-defined error is sent to an action system of the device to generate an event in step 316. A customer-defined error may be an error that occurs when certain thresholds defined by a customer are exceeded. For example, if a customer determined a temperature range as a range between 30 F and 40 F as acceptable inside a refrigerator, and the temperature range was exceeded at some point in time, then the refrigerator's application may generate a customer-defined error indicating that the acceptable temperature has been exceeded.

If a manufacturer-defined event is detected on a device, then event information 312, indicating a manufacturer-defined error is sent to an action system of the device to generate an event in step 316. A manufacturer-defined error may be an error that occurs when certain maintenance guidelines, defined by the manufacturer, are exceeded. For example, if a manufacturer determined that an elevator should be inspected every three months, and the elevators has not been inspected for more than three months, then the elevator's application may generate a manufacturer-defined error indicating that the recommended inspection has not taken place.

If a vendor-defined event is detected on a device, then event information 313, indicating a vendor-defined error is sent to an action system of the device to generate an event in step 316. A vendor-defined error may be an error that occurs when the vendor's recommendations for using certain parts are disregarded. For example, if a vendor determined that only the ink cartridge manufactured by the vendor may be used in a particular MFP, and a user tried to use the ink cartridge manufactured by another manufacturer in the particular MFP, then the MFP's application may generate a vendor-defined error indicating that the vendor recommendations has been disregarded.

If a system-defined event is detected on a device, then event information 314, indicating a system-defined event is sent to an action system of the device to generate an event in step 316. A system-defined error may be an error that occurs when the system-defined rules are disregarded by components of the device. For example, if an application executed on a personal computer causes a memory dump in the personal computer, then the system may generate a memory-dump error as a system-defined error.

If a scheduler-defined event is detected on a device, then event information 315, indicating a scheduler-defined event is sent to an action system of the device to generate an event in step 316. A scheduler-defined event may be an error that occurs when for some reason a scheduled event did not take place in the device. For example, if a wireless device was programmed to generate a wakeup call at a particular time, but the wakeup call was not made at the particular time, then the scheduler application may generate a scheduler-defined error indicating that the scheduled wakeup call was not made.

Examples depicted in FIG. 3A are provided to merely illustrate some types of events detected by sensor applications of an electronic devices.

### C. Event Processing

FIG. 3B is a flow diagram that depicts an approach for processing event data and generating event communications. The example steps may be performed by any type of electronic device, such as an electronic device 110 of FIG. 1, or an electronic device 205 of FIG. 2.

In the context of print devices, the steps depicted in FIG. 3 may be performed by for example, a print device, a fax machine, a multifunctional print device, or any other device capable of executing print jobs. For the purpose of illustration, examples described below refer to a print device such as a printer; however, the examples should not be considered as limiting in reference to the presented approach.

In step 310, data representing a plurality of event categories is received and stored. A plurality of categories may be defined prior to deploying an event detection and notification system, and may be modified during the deployment of the system. For example, as a new electronic device is added to the system, one or more new categories may be added to the plurality of the categories to capture new categories of events possibly taking place in the new device. Examples of the event categories include, without limitation, an error category, a warning category, a maintenance request category, and a power failure category. The data representing an event category comprises a category description, information indicating one or more recipients and a description of one or more actions.

In step 320, event data indicating an event occurring in the electronic device is received. For example, upon detecting a problem with a printer, the process may generate event data indicating the problem. Event data may indicate for example that execution of a data processing application on a printer failed, that printing of a particular print job was successful, or that printing of a particular print job failed because there was no paper in a paper tray in the printer.

In step 330, a category is determined for the event for which event data was received. A category may be determined for the event based on the plurality of categories stored in step 310. For example, an event related to printing problems occurring on MFP devices may be categorized as a MFP-printing-problem; while an event related to a freezer malfunctioning in an industrial refrigerator may be categorized as a freezer-problem.

One or more categories or sub-categories may be associated with an event. For example, an event pertaining to printing problems on a MFP device may be categorized as a printing problem, as a MFP problem, or as a MFP problem with a printing problem sub-category.

In step 340, one or more recipients are identified. A recipient is an individual or an entity that requested to receive event communications when events associated with a certain category of events occur on a particular device or a particular group of devices. Determining a recipient for a particular event may be performed based on a particular event category and the information associated with the particular category. The associated information may indicate one or more recipients who wish to be notified when an event associated with the particular category is detected. For example, if a particular technician responsible for maintaining MFP devices within an organization indicates that, each time a printing problem occurs on any of the MFP devices, he wishes to be notified about the problem, a name (or some type of an identification) of the technician may be stored in an association with the particular event category. When the printing problem associated with the particular category occurs, using the information stored in the association with the particular category, the process may determine the particular technician as one of the recipients of communications related to printing problems on the MFP devices.

Also in step 340, for each identified recipients, the process may determine a method for communicating with the recipient. For example, a particular user may have specified one or more methods for reaching the user. One of these methods may be identified as a preferred method. For example, a particular user may specify that the preferred method for contacting him is over a phone. The user may also indicate that if the preferred method of contacting him fails, then the user may be contacted using a pager or by email.

Communications method preferences may be received from a user at the time the user creates a user profile. For example, as a user accesses his user account on a system, the user may be prompted to create a user profile and indicate one or more communications methods in the profile. Alternatively, a user may specify a preferred communications method by contacting a system administrator or other entity responsible for collecting that type of information. A user may also be asked to indicate his preferred communications method when the system is deployed or when problems are detected on a particular device.

If a process cannot determine a preferred communications method for a particular recipient, then the process may select a default communications method for the recipient. For example, the process may determine an email address of the recipient, and use an email as the default communications method for the recipient. According to another example, the process may determine an office phone number for the recipient, and indicate that making a phone call is the default communications method for the recipient.

In step 350, the process determines whether any remedial action may be recommended to a recipient. Determination of a remedial action may depend on the event category assigned to the event. If a detected event is non-critical in nature, then the process may ignore such events, and forgo recommending remedial actions to the recipients. However, if a detected event indicates for example, a failure of a critical component of an electronic device, then the process may recommend performing one or more remedial actions. For example, if the process detects that a particular MFP device is out of ink, then the process may recommend replenishing the ink in the device. According to another example, if the process detects that a particular industrial refrigerator stopped working, then the process may recommend contacting a vendor who services the particular refrigerator and requesting servicing of the refrigerator.

If in step 350 the process determined that the event is non-critical and that no remedial action is recommended, then the process proceeds to step 355. Otherwise, the process proceeds to step 360.

In step 355, the process determines whether at least a notification about the detected event may be sent to recipients. If so, then the process proceeds to step 357. Otherwise, the process proceeds to step 320, and awaits another event data.

In step 357, a notification indicating a detected event is created and sent to one or more recipients. A notification may be created in a variety of ways. For example, a process may generate a text message, and include in the message an identifier of the event, an identifier of the electronic device on which the event was detected, and any other information helpful in identifying the event, such as a classification identifier or an event category identifier. A notification message may also include a brief description of the detected event, a status indicator, a warning code, or an error message related to the event.

In step 360, the process generates an event communication and sends the communication to one or more recipients. An event communication may be an email, a text message, a phone call, or any other type of communications indicating a detected event to a recipient. For example, an event communication may be an email that is addressed to a recipient and that comprises a description of the detected event, an indication of the event category associated with the detected event, one or more recommended remedial actions, and any other information further describing the detected event.

Also in step 360, the communication is sent to each of the recipients. If a preferred communications method for a particular recipient is known, then the process transmits the communication to the particular recipient using the preferred method. However, if a preferred communications method is not known, then the process transmits the communication to the particular recipient using a default method.

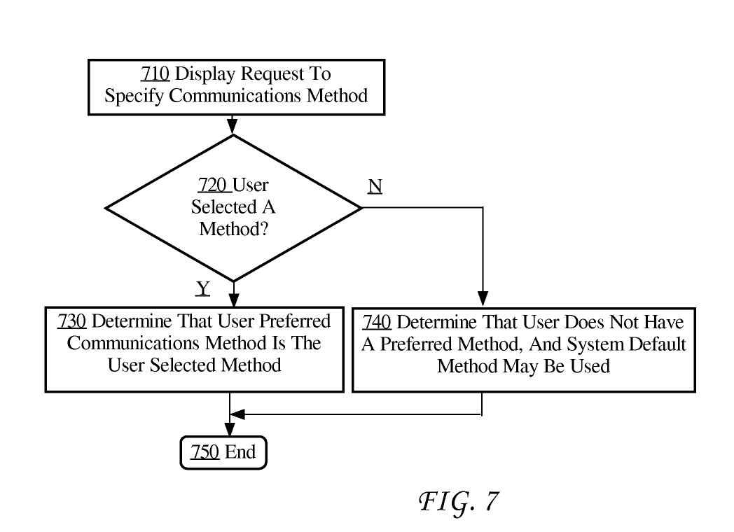

Information about a preferred communications method and default communications method may be stored in storage of an electronic device that executes the steps depicted in FIG. 3B, or in storage device implemented in a separate server. The information about preferred or default communications methods may be generated at the time a user subscribes to the services offered by the electronic devices, and the information may be stored in a server dedicated to storing user profiles. For example, when a user subscribes to the services, a user profile may be created for the user, and the user profile may be stored on the user profile server. One of the approaches for generating and storing information related to a user communications method in a user profile server is depicted in FIG. 7.

In response to transmitting a communication to one or more recipients, a response to the communication may be received from the recipients.

In step 370, the process determines whether a response is received from a recipient. Usually if the process communicated the event communication to the recipient using a particular communications method, then the response to the event communications may be delivered to the process using the same particular communications method. However, in some embodiment, the process may communicate the event communications to a user using one communications method and receive responses to the communications using another communications method. For example, if an event communication is delivered to a recipient as content of a web page, displaying an interactive menu, then the recipient may provide a response by sending a user selection of the option from the interactive menu. According to another example, if the process transmitted an email to the recipient, then the recipient may respond with an email as well.

If in step 370 a determination is made that a response is received, then the process proceeds to step 380. Otherwise, the process proceeds to step 320, and awaits event data.

In step 380, the process determines whether a received response indicates a local action or a remote action. Upon receiving a response, the process parses the response and identifies one or more actions included in the response. The actions usually correspond to remedial actions that the process recommended to the recipient. However, the actions may also indicate actions that were not recommended by the process to the recipient.

An action is local if it may be performed by an application or a process executed directly on the device on which the event was detected. For example, a local action may indicate a request to restart the device, or a request to power off the device.

An action is remote if it may not be performed by an application or a process executed directly on the device, and instead, it may need to be executed by a remote entity, such as a vendor company, a part supplier or a manufacturer. For example, a remote action may indicate that a particular part needs to be ordered from a part supplier, or that a technician from a vendor company needs to be contacted.

If an action is local, then the process proceeds to step 385. Otherwise, the process proceeds to step 390.

In step 385, the process processes a local action. Processing of a local action may involve translating the local action information into one or more commands recognizable by the device on which the problem was detected. For example, if a local action indicated that a particular printing device should switch from printing using paper from an A4 paper tray to printing using paper from a legal paper tray, then the selected action may be translated into commands that can be understood by the particular printing device and that would cause the switching.

Once a local action is translated into commands that the device understands, the process initiates execution of the commands on the device. Upon completion of the execution of the commands, the process proceeds to step 399, and ends the processing of the event.

In step 390, one or more remote actions are processed. For example, if a particular remote action suggested contacting a vendor technician or ordering some parts for the device from a part supplier, then the process may try to determine the vendor or the part supplier and generate a service order or work order. Additional details pertaining to the processing of a remote action are provided in FIG. 3C.

FIG. 3C is a flow diagram that depicts an approach for processing a remote action. In step 391, the process determines whether a remote action pertains to a service that is free of charge. A service may be free of charge if the device is under warranty, or a user of the device already paid for servicing the device. If the remote action pertains to a service that is free of charge, then the process proceeds to step 392. Otherwise, the process proceeds to step 393.

In step 392, based on a description of the remote action, an order request is generated and sent to a vendor. For example, the description may indicate that a particular part needs to be ordered; thus the process may generate a part order for the particular part and send the part order to the vendor.

In step 393, based on a description of the remote action, an order request and a payment for the service are generated. For example, the description may indicate that an elevator needs to be serviced by a vendor; thus the process may generate a service request for the vendor to service the elevator.

In step 394, the process determines whether an invoice option is available from a vendor. For example, some vendors allow invoicing customer for the services after the service is performed; others require that the services be prepaid. If in step 394, the process determines that an invoice payment option is available from the vendor, then in step 397, the process sends the order request with an automatic payment to the vendor.

However, if in step 394, the process determined that an invoice payment is not available from a vendor, then the process determines whether a user provided any payment information, such as a charge card number or a bank account number, and whether the user authorized automatic payments. If so, then the user's provided payment information is sent along with the order request to the vendor. However, if the user did not provide any payment information, then the process contacts the user to either provide the payment information, or to place the order request manually.

### D. Dispatching Event Communications

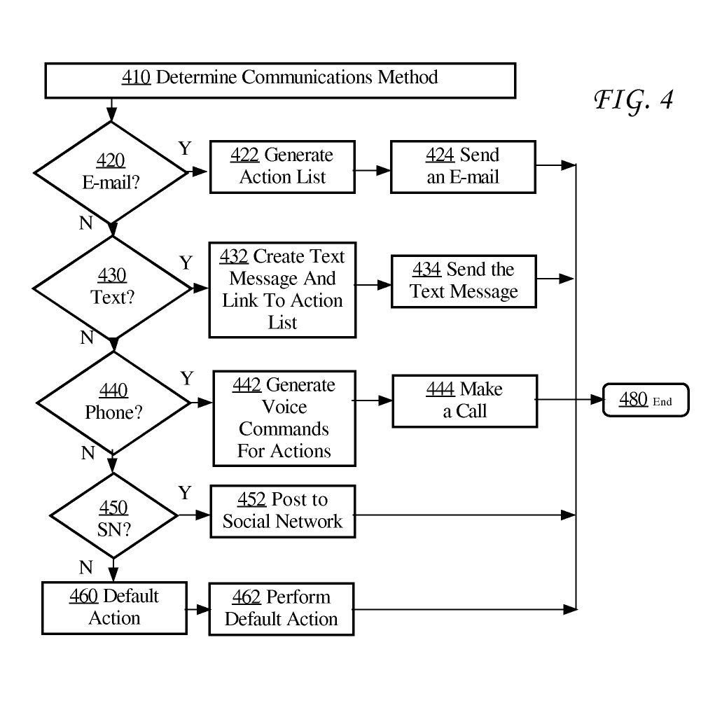

FIG. 4 is a flow chart that depicts an example process of dispatching an event communication. In step 410, a communications method is determined for a communication recipient to whom an event communication should be sent from an electronic device. As described above, a communications method for a communication recipient may be determined based on a user profile associated with the communication recipient. Such a communications method is referred herein as a preferred communications method because it is the method via which the communication recipient prefers to receive communications. However, if a preferred communications method is not specified, then a default communications method may be used. Various types of preferred communications methods and default communications methods are described above.

The description below refers to a “communications” method without differentiating whether the communications method is preferred or default.

Decision steps 420, 430, 440 and 450 refer to example steps for determining communications methods. In embodiments, additional or even different decision steps may be implemented.

In step 420, a determination is made whether a communications method is an email-based communications method. If so, then in step 422, a communication email is created, and a determination is made whether one or more recommended actions pertaining to a detected event can be identified.

If one or more recommended actions are identified, then a list of the one or more recommended actions is generated. The list may comprise various types of information indicating the one or more recommended actions. For example, a recommended action may be represented by a Uniform Resource Locator (URL), and the URL information may be included in the list. Alternatively, a recommended action may be represented by a code and the code information may be included in the list. The list of one or more recommended actions may comprise a combination of URLs, codes and other information identifying the recommended actions.

Also in step 422, a list of recommended actions (if such are available) is included in a communication email.

In step 424, a communication email, comprising a communication and an action list, is sent to a communication recipient. Subsequently, the process proceeds to step 480, in which generating of the communication is ended.

However, if in step 420, it was determined that a communications method was not an email-based communications method, then, in step 430, a determination is made whether the communications method is a text-message-based communications method. If so, then in step 432, a communication text message is created, and a determination is made whether one or more recommended actions can be identified.

If one or more recommended actions are identified, then, as in step 432, a set of the one or more recommended actions is generated. Also in step 432 a hyperlink to an action list (if such a list is available) may be included in a communication text message.

In step 434, a communication text message, comprising a communication and a hyperlink to an action list is sent to a communication recipient. Subsequently, the process proceeds to step 480, in which generating of the communication is ended.

However, if in step 430, it was determined that a communications method was not a text-message-based communications method, then, in step 440, a determination is made whether the communications method is a telephonic method. If so, then, in step 442, a communication call is generated, and a determination is made whether one or more recommended actions can be identified.

If one or more recommended actions are identified, then, an audio menu corresponding to the one or more recommended actions is generated. The audio menu may be organized as an association between the actions and menu options, in which the recommended actions are associated with the menu options, and the menu options are associated with keys of a telephone keypad.

Also in step 442, an audio recording indicating a detected event and the menu with an audio menu indicating one or more recommended actions, if such are available, are included in a communication call.

In step 444, a communication call is made and an audio recording is played once the call is accepted by a communication recipient. The call may comprise a voice message indicating a detected problem and an audio menu with options indicating recommended actions, if such are available. Subsequently, the process proceeds to step 480, in which generating of the communication is ended.

However, if in step 440, it was determined that a communications method was not a telephonic method, then, in step 450, a determination is made whether the communications method specifies communicating via a social network (or a social medium). If so, then in step 452, a determination is made whether one or more recommended actions can be identified. Also in step 452, a communication about a detected event and information about the recommended actions (if such are available) is posted to the social network.

Implementations of posting to a social network may vary. Hence, the specific details of communication posting to a social network depend on how the social network is implemented and accessible. Therefore, it is assumed here that any method of posting a communication to a social network may be used in step 452, depicted in FIG. 4.

Once step 452 is completed, the process proceeds to step 480, in which generating of the communication is ended.

While FIG. 4 depicts testing whether a communications method is any one of email-based communications, text-message-based communications, telephonic communications, or social network communications, other types of communications method may also be implemented.

If a communication method determined in step 410 does not correspond to any of the known or predefined communications methods, then in step 460, a determination is made that a default action may be pursued. A default action may be any action that an electronic device may perform without actually sending a communication to a user device. For example, a default action may comprise logging a communication (and possibly a set of recommended actions) to a system log file maintained on the electronic device. Alternatively, a default action may comprise creating an error-system-file and storing information related to the communication in the error-system-file.

In step 462, a default action is performed. For example, a communication indicating a detected event is logged into a system log file, or an error-system-file is created and the communication is stored in the error-system-file for a system administrator to review. Subsequently, the process proceeds to step 480, in which generating of the communication is ended.

### E. Generating Responses to Event Communications

Selecting a particular action as suitable for addressing an event indicated in a received communication may depend on a variety of factors. For example, a selection may be based on experience of a user, user's knowledge of the circumstances surrounding the event, policies and procedures implemented in the organization, convenience, and some other factors. For example, if an event communication indicates that printing of a document on an A4 format paper is not possible because the tray with A4 paper is empty, and the communications may suggest a few recommended actions, such as 1) replenishing paper in the A4 paper tray, 2) using a tray with a legal-format paper, 3) sending a request to a system administrator to reload the A4 tray with the paper, and 4) saving the print job on a server for a future printing, the user may determine that the particular print job may be completed on the legal-format paper. If it is important to the user that a particular print job uses A4-format paper, then the user may select the third option, which suggests sending a request to a system administrator to reload the A4 try with paper. Alternatively, if the user is located in the vicinity of the particular print device, then the user may just walk up to the printer and reload the A4 paper tray.

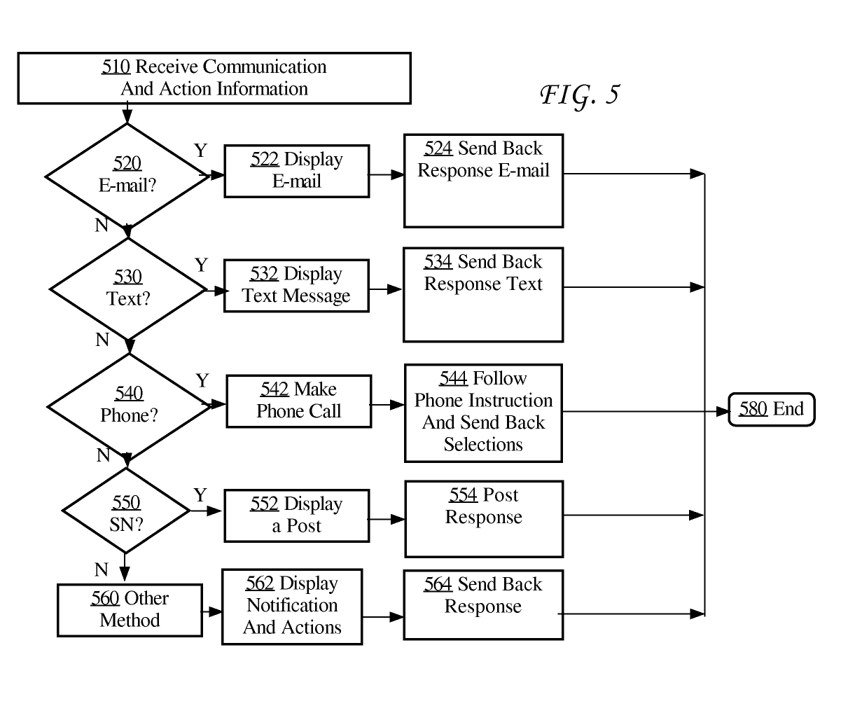

FIG. 5 is a flow diagram that depicts an example process of generating a response to an event communication. A process of generating a response to an event communication may be performed by a user who received the event communication on the user device.

For the purpose of illustration clear examples, the description below refers to the situation in which an event communication is sent with information about recommended actions. Other situations, in which event communications were sent without recommended action information, may be interpreted as simplified variations of the description provided below.

In step 510, event communication and recommended action information is received at a user device.

In step 520, a determination is made whether a communication and action information was received in a form of an email. If so, then the email with the event communication and action information is displayed as an email for a user. The event communication and action information may be included in a body of the email. The action information may include information about one or more recommended actions. Further, instructions may be displayed indicating that the user may select one or more recommended actions, and indicate the selected options as the ones to be performed on an electronic device to remedy a problem indicated in the communication.

In step 524, a process assists a user in generating a response email. In the response email, a user may include information about a particular action, selected from one or more recommended actions displayed for the user. The information about the selected particular action may be a URL to the selected action and may be included in a body of the response email. Also in step 524, the response email is sent to an electronic device, and the process proceeds to step 580 to end the processing of the response.

In step 530, a determination is made whether a communication and action information was received as a text message. If so, then, in step 532, the text message with the event communication and action information is displayed for the user.

In step 534, a process assists a user in creating a response text message. In the response text message, a user may include information about a particular action (URL), selected from one or more recommended actions displayed for the user. Also in step 534, the response text message is sent to an electronic device, and the process proceeds to step 580 to end the processing of the response.

In step 540, a determination is made whether a communication and action information was received as a phone call. If so, the phone call is put through to the user, and, in step 542, an audible version of the communication and an audible menu with one or more recommended actions are played for the user.

In step 544, a process assists a user in following audio menu instructions to navigate through a menu indicating one or more recommended actions. Further, the process collects the user selections and sends the user selections to an electronic device, and proceeds to step 580 to end the processing of the response.

In step 550, a determination is made whether a communication and action information was delivered to a user social network account, and if so, in step 552, a social network post is made available to the user. Since implementations of posting to social networks may vary, any known method of displaying and processing social network posting may be used in step 552.

In step 554, a process assists a user in posting a response to a social network. Since implementations of posting to social networks may vary, any known method of generating and submitting a posting to the social network may be used in step 554. The response may include a selected action that the user selected as suitable to remedy the problem indicated in the received communication.

In step 560, a determination is made whether a communication and action information should be displayed using any other, not mentioned above, method. If so, in step 562, the received communication and action information is displayed for the user using a particular method.

In step 564, a process assists a user in selecting a particular action from one or more recommended actions, and in preparing a response including the selected particular action. Furthermore, in step 564, the process sends the response to an electronic device and proceeds to step 580 to end the processing of the response.

### F. Response Processing

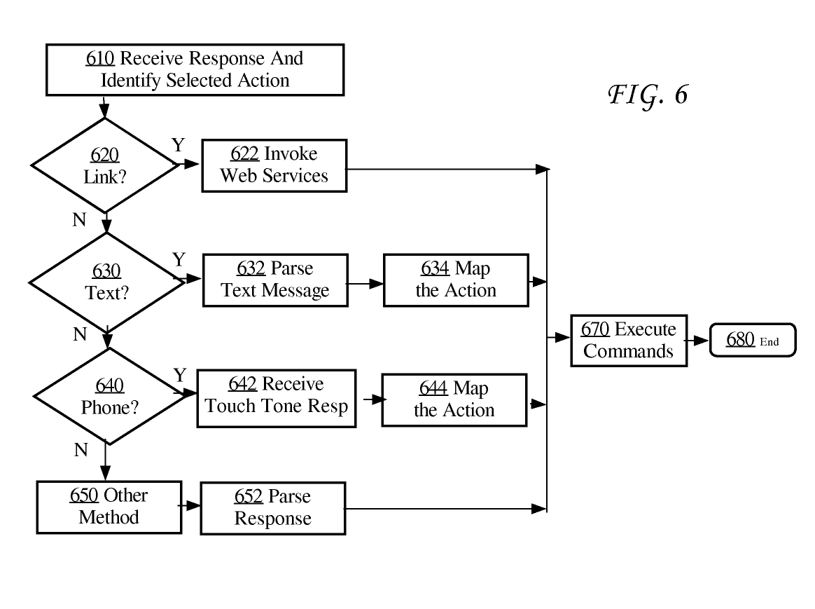

FIG. 6 is a flow chart that depicts an example of processing a response received by an electronic device. The depicted processing of the received response may be performed by an application executing on an electronic device that sent a communication.

In step 610, a response from a user device is received by an electronic device. The response may, but does not have to, include information about a selected action that the user requested that be performed on the electronic device. If the information about the selected action is included in the response, then the selected action information is extracted from the communication.

In step 620, a determination is made whether the selected action information is in a form of a web link. If so, then in step 622, the process invokes web services, requests a web page addressed by the web link that identifies one or more commands that correspond to the selected actions, and that an electronic device can understand. Then, the process proceeds to step 670, in which the commands are executed to remedy a problem identified in a communication, and proceeds to step 680 to end processing of the response.

In step 630, a determination is made whether selected action information is in a form of a text message. If so, then in step 632, the text message is parsed to identify the selected action, and in step 634, the selected action is mapped onto one or more commands, which an electronic device can understand and execute. Then, in step 670, the commands are executed to remedy a problem identified in a detected event, and proceeds to step 680 to end processing of the response.

In step 640, a determination is made whether selected action information was communicated via a telephone, and if so, in step 642, the process accepts a touch-tone response, and parses the response to identify a selected action.

In step 644, a selected action is mapped onto one or more commands, which an electronic device can understand and execute. Then, in step 670, the commands are executed to remedy a problem identified in a detected event, and proceeds to step 680 to end processing of the response.

In step 650, a determination is made whether selected action information was communicated using any method other than the methods described in steps 620, 630, and 640. If so, the communications method is identified, and, in step 652, the response is parsed, one or more commands understood by an electronic device are identified, and, in step 670, the one or more commands are performed on the electronic device. Then, the process proceeds to step 680 to end processing of the response.

Other methods and approaches for receiving a response to an event communication and for performing a selected action identified in the received response may also be implemented.

### G. Determining Communications Methods

FIG. 7 is a flow chart that depicts an example process of defining a communications method for a user. A process of defining a communications method for a user may be performed independently from detecting events and processing communication on an electronic device. For example, the process of defining a communications method may be performed in advance and by an application executed on a device other than the electronic device. For instance, the process may be performed by an application executed on a user profile server or any other server or device configured to collect data from a user.

A process of defining a communications method for a user may be implemented in a software application that updates a user profile for the user or that updates any other data structure that stores user configuration for the user. Although a process of defining a communications method is described below in the context of creating and updating user profiles, other implementations of the process may be pursued.

In step 710, a request to specify a communications method is generated by a server application and displayed for a user. For example, as a user profile is created for a user, a user profile application may generate a request to specify a preferred communications method via which the user wishes to communicate with a particular electronic device, and display the request for the user. Alternatively, a user may invoke a user profile application each time when he wishes to update his profile. Once invoked, the user profile application may allow the user to either overwrite the user's previous selection or provide a new selection of a preferred communications method for the user.

A request may be displayed in a form of a question and/or a menu comprising a description of one or more communications methods. The menu may be interactive and allow the user to select a preferred communications method from the one or more displayed communications method. The menu may also have an option allowing the user to forgo the request and bypass the selection of the preferred communications method.

In step 720, a determination is made whether a user selected one method from one or more communications method displayed for the user in a menu. If the user selected one communications method, then, in step 730, the selected method is assumed to be a preferred communications method, and the information indicating the preferred communications method is stored in a user profile. Subsequently, the process proceeds to step 750, which ends the preferred method selection process.

However, if in step 720, a determination is made that a user has not selected any method from one or more communications method displayed for the user in a menu, then, in step 740, it is assumed that the user does not have a preferred communications method, and that if needed, a default communications method may be used to communicate communications from an electronic device to the user. Subsequently, the process proceeds to step 750, which ends the preferred method selection process.

Referring again to FIG. 3, if in step 330, a list of communication recipients has been determined for a particular communication, then for each communication recipient from the list, a preferred communications method may be determined. The preferred communications methods for the communication recipients may be different for some recipients, and/or may be the same for other recipients.

If a preferred communications method for a communication recipient has not been defined or otherwise provided, then a default communications method is retrieved and may be used

### IV. Implementation Mechanisms

Although the flow diagrams of the present application depict a particular set of steps in a particular order, other implementations may use fewer or more steps, in the same or different order, than those depicted in the figures.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, mobile computer systems, handheld devices, networking devices or any other device that incorporates hard-wired and/or program logic to implement the techniques.

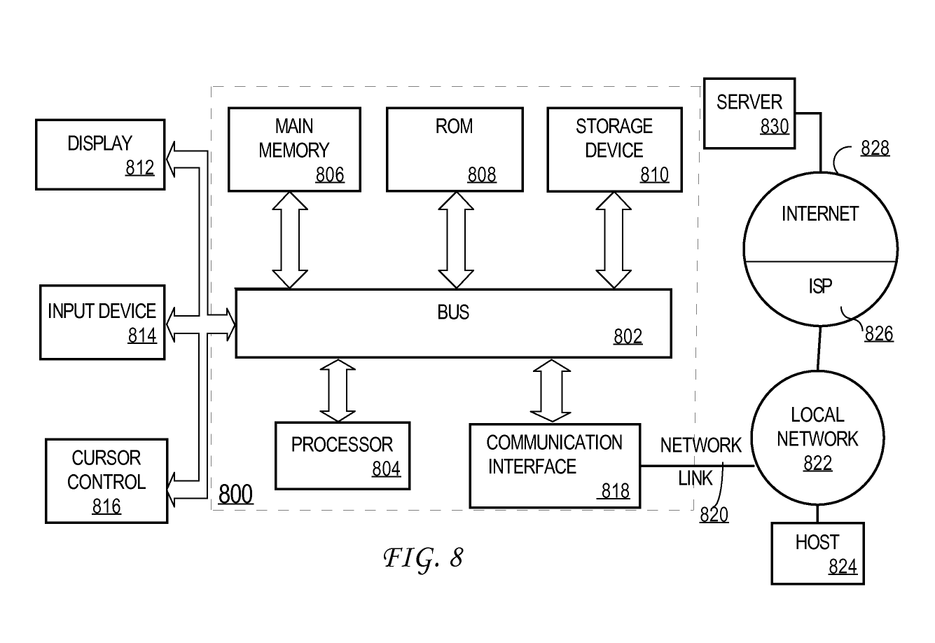

FIG. 8 is a block diagram that depicts an example computer system 800 upon which embodiments may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic or computer software which, in combination with the computer system, causes or programs computer system 800 to be a special-purpose machine. According to one embodiment, those techniques are performed by computer system 800 in response to processor 804 executing one or more sequences of one or more instructions contained in main memory 806. Such instructions may be read into main memory 806 from another computer-readable medium, such as storage device 810. Execution of the sequences of instructions contained in main memory 806 causes processor 804 to perform the process steps described herein. In alternative embodiments, hard-wired circuitry may be used in place of or in combination with software instructions to implement embodiments described herein. Thus, embodiments are not limited to any specific combination of hardware circuitry and software.

The term “computer-readable medium” as used herein refers to any medium that participates in providing data that causes a computer to operation in a specific manner. In an embodiment implemented using computer system 800, various computer-readable media are involved, for example, in providing instructions to processor 804 for execution. Such a medium may take many forms, including but not limited to, non-volatile media and volatile media. Non-volatile media includes, for example, optical or magnetic disks, such as storage device 810. Volatile media includes dynamic memory, such as main memory 806. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. The received code may be executed by processor 804 as it is received, and/or stored in storage device 810, or other non-volatile storage for later execution.

1. A method comprising:
receiving and storing data representing a plurality of event categories for a plurality of events detectable on a plurality of electronic devices;
wherein the data representing an event category, from the plurality of event categories, comprises a category description, information indicating one or more recipients and a description of one or more actions;
receiving, from a particular electronic device, from the plurality of electronic devices, event data associated with a particular event, from a plurality of events, occurring at the particular electronic device;
based, at least in part, on the event data and the plurality of event categories, determining, by one or more computers, for the particular event, a particular event category, from the plurality of event categories;
based, at least in part, on the particular event category, determining, by the one or more computers, one or more recipients and an indication whether one or more actions are associated with the particular event category;
in response to determining that the one or more actions are associated with the particular event category: for each recipient, from the one or more recipients:
determining, by the one or more computers, whether a preferred communications method for communicating with the recipient has been specified by one or more of: the recipient, a customer, a system administrator, or a user;
in response to determining that the preferred communications method for communicating with the recipient has been specified, transmitting, by the one or more computers, to the recipient according to the preferred communications method, a communication specifying the particular event and the one or more actions;
wherein the method is performed by one or more computing devices.

2. The method of claim 1,
wherein the event data associated with the particular event occurring at the particular electronic device is received after an event detection unit detects any of the following: a customer-defined error, a manufacturer-defined error, a retailer-defined error, a vendor-defined error, a system-administrator-defined error, a system-scheduler-defined error, a customer-defined warning, a manufacturer-defined warning, a retailer-defined warning, a vendor-defined warning, a system-administrator-defined warning and a system-scheduler-defined warning.

3. The method of claim 1, further comprising:
in response to transmitting to the recipient the communication specifying the particular event and the one or more actions, receiving user data indicating a user selection of a particular action, from the one or more actions, to be performed with respect to the particular electronic device;
based at least in part on the user selection of the particular action, determining whether the particular action is to be performed locally on the particular electronic device;
in response to determining that the particular action is not to be performed locally on the particular electronic device:
retrieving contact information of a remote entity responsible for performing the particular action;
using the contact information, contacting the remote entity responsible for performing the particular action;
in response to determining that the particular action is to be performed locally on the particular electronic device:
determining one or more commands, execution of which causes execution of the particular action; and
executing the one or more commands with respect to the electronic device.

4. The method of claim 3, wherein contacting a remote entity responsible for performing the particular action comprises:
determining whether services indicated by the particular action are to be provided by the remote entity free of charge;
in response to determining that the services indicated by the particular action are to be provided by the remote entity free of charge, transmitting, to the remote entity, the user data indicating the particular action and the particular event, and optionally, notifying the recipient that the remote entity has been contacted;
in response to determining that the services indicated by the particular action are not to be provided by the remote entity free of charge:
determining whether the recipient has approved an automatic payment for the service indicated by the particular action;
in response to determining that the recipient has approved the automatic payment for the service:
retrieving payment information for the service;
generating a service request that comprises the payment information, the particular action and the particular event; and
sending the service request to the remote entity;
otherwise notifying the recipient that the payment information is requested.

5. The method of claim 1, further comprising:
in response to determining that the preferred communications method for communicating with the recipient has not been specified, selecting a default communications method and transmitting to the recipient, according to the default communications method, the communication specifying the particular event and the one or more actions.

6. The method of claim 1, wherein the communication comprises any one of: a warning, an error notification, a warning exception, a communications problem message, a printing problem message, and a maintenance notification.

7. The method of claim 1,
wherein a user provided definition of the preferred communications method is included in a user individual profile;
wherein the preferred communications method comprises any one of: an email, a text message, a phone call, a social media communication and other forms of communicating information.

8. The method of claim 1,
wherein the data representing the plurality of event categories for the plurality of events detectable on the plurality of electronic devices is dynamically reconfigurable and modifiable by any one of: a customer, a manufacturer, a retailer, a vendor, and a system administrator.

9. A non-transitory computer readable storage medium, storing one or more instructions which, when executed by one or more processors, cause the one or more processors to perform:
receiving and storing data representing a plurality of event categories for a plurality of events detectable on a plurality of electronic devices;
wherein the data representing an event category, from the plurality of event categories, comprises a category description, information indicating one or more recipients and a description of one or more actions;
receiving, from a particular electronic device, from the plurality of electronic devices, event data associated with a particular event, from a plurality of events, occurring at the particular electronic device;
based, at least in part, on the event data and the plurality of event categories, determining, for the particular event, a particular event category, from the plurality of event categories;
based, at least in part, on the particular event category, determining one or more recipients and an indication whether one or more actions are associated with the particular event category;
in response to determining that the one or more actions are associated with the particular event category: for each recipient, from the one or more recipients:
determining whether a preferred communications method for communicating with the recipient has been specified by one or more of: the recipient, a customer, a system administrator, or a user;
in response to determining that the preferred communications method for communicating with the recipient has been specified, transmitting, to the recipient according to the preferred communications method, a communication specifying the particular event and the one or more actions.

10. The non-transitory computer readable storage medium of claim 9,
wherein the event data associated with the particular event occurring at the particular electronic device is received after an event detection unit detects any of the following: a customer-defined error, a manufacturer-defined error, a retailer-defined error, a vendor-defined error, a system-administrator-defined error, a system-scheduler-defined error, a customer-defined warning, a manufacturer-defined warning, a retailer-defined warning, a vendor-defined warning, a system-administrator-defined warning and a system-scheduler-defined warning.

11. The non-transitory computer readable storage medium of claim 9, further comprising instructions which, when executed, cause the one or more processors to perform:
in response to transmitting to the recipient the communication specifying the particular event and the one or more actions, receiving user data indicating a user selection of a particular action, from the one or more actions, to be performed with respect to the particular electronic device;
based at least in part on the user selection of the particular action, determining whether the particular action is to be performed locally on the particular electronic device;
in response to determining that the particular action is not to be performed locally on the particular electronic device:
retrieving contact information of a remote entity responsible for performing the particular action;
using the contact information, contacting the remote entity responsible for performing the particular action;
in response to determining that the particular action is to be performed locally on the particular electronic device:
determining one or more commands, execution of which causes execution of the particular action; and
executing the one or more commands with respect to the electronic device.

12. The non-transitory computer readable storage medium of claim 11, wherein the instructions that cause the one or more processors to perform contacting a remote entity responsible for performing the particular action further comprise instructions that cause the one or more processors to perform:
determining whether services indicated by the particular action are to be provided by the remote entity free of charge;
in response to determining that the services indicated by the particular action are to be provided by the remote entity free of charge, transmitting, to the remote entity, the user data indicating the particular action and the particular event, and optionally, notifying the recipient that the remote entity has been contacted;
in response to determining that the services indicated by the particular action are not to be provided by the remote entity free of charge:
determining whether the recipient has approved an automatic payment for the service indicated by the particular action;
in response to determining that the recipient has approved the automatic payment for the service:
retrieving payment information for the service;
generating a service request that comprises the payment information, the particular action and the particular event; and
sending the service request to the remote entity;
otherwise notifying the recipient that the payment information is requested.

13. The non-transitory computer readable storage medium of claim 9, further comprising instructions which, when executed, cause the one or more processors to perform:
in response to determining that the preferred communications method for communicating with the recipient has not been specified, selecting a default communications method and transmitting to the recipient, according to the default communications method, the communication specifying the particular event and the one or more actions.

14. The non-transitory computer readable storage medium of claim 9,
wherein the communication comprises any one of: a warning, an error notification, a warning exception, a communications problem message, a printing problem message, and a maintenance notification;
wherein a user provided definition of the preferred communications method is included in a user individual profile;
wherein the preferred communications method comprises any one of: an email, a text message, a phone call, a social media communication and other forms of communicating information;
wherein the data representing the plurality of event categories for the plurality of events detectable on the plurality of electronic devices is dynamically reconfigurable and modifiable by any one of: a customer, a manufacturer, a retailer, a vendor, and a system administrator.

15. An apparatus comprising:
one or more processors,
an event categorization unit configured to:
receive and storing data representing a plurality of event categories for a plurality of events detectable on a plurality of electronic devices;
wherein the data representing an event category, from the plurality of event categories, comprises a category description, information indicating one or more recipients and a description of one or more actions;
an event detection unit configured to:
receive, from a particular electronic device, from the plurality of electronic devices, event data associated with a particular event, from a plurality of events, occurring at the particular electronic device;
an event processing unit configured to:
based, at least in part, on the event data and the plurality of event categories, determine, for the particular event, a particular event category, from the plurality of event categories;
an action unit configured to:
based, at least in part, on the particular event category, determine one or more recipients and an indication whether one or more actions are associated with the particular event category;
a communications unit configured to:
in response to determining that the one or more actions are associated with the particular event category: for each recipient, from the one or more recipients:
determine whether a preferred communications method for communicating with the recipient has been specified by one or more of: the recipient, a customer, a system administrator, or a user;
in response to determining that the preferred communications method for communicating with the recipient has been specified, transmit, to the recipient according to the preferred communications method, a communication specifying the particular event and the one or more actions.

16. The apparatus of claim 15,
wherein the event detection unit receives the event data associated with the particular event after the event detection unit detects any of the following: a customer-defined error, a manufacturer-defined error, a retailer-defined error, a vendor-defined error, a system-administrator-defined error, a system-scheduler-defined error, a customer-defined warning, a manufacturer-defined warning, a retailer-defined warning, a vendor-defined warning, a system-administrator-defined warning and a system-scheduler-defined warning.

17. The apparatus of claim 15, wherein the communication unit is further configured to:
in response to transmitting to the recipient the communication specifying the particular event and the one or more actions, receive user data indicating a user selection of a particular action, from the one or more actions, to be performed with respect to the particular electronic device;
based at least in part on the user selection of the particular action, determine whether the particular action is to be performed locally on the particular electronic device;
in response to determining that the particular action is not to be performed locally on the particular electronic device:
retrieve contact information of a remote entity responsible for performing the particular action;
using the contact information, contact the remote entity responsible for performing the particular action;
in response to determining that the particular action is to be performed locally on the particular electronic device:
determine one or more commands, execution of which causes execution of the particular action; and
execute the one or more commands with respect to the electronic device.

18. The apparatus of claim 17, wherein the communication unit is further configured to:
determine whether services indicated by the particular action are to be provided by the remote entity free of charge;
in response to determining that the services indicated by the particular action are to be provided by the remote entity free of charge, transmit, to the remote entity, the user data indicating the particular action and the particular event, and optionally, notify the recipient that the remote entity has been contacted;
in response to determining that the services indicated by the particular action are not to be provided by the remote entity free of charge:
determine whether the recipient has approved an automatic payment for the service indicated by the particular action;
in response to determining that the recipient has approved the automatic payment for the service:
retrieve payment information for the service;
generate a service request that comprises the payment information, the particular action and the particular event; and
send the service request to the remote entity;
otherwise, notify the recipient that the payment information is requested.

19. The apparatus of claim 15, wherein the communication unit is further configured to:
in response to determining that the preferred communications method for communicating with the recipient has not been specified, select a default communications method and transmit to the recipient, according to the default communications method, the communication specifying the particular event and the one or more actions.

20. The apparatus of claim 15,
wherein the data representing the plurality of event categories for the plurality of events detectable on the plurality of electronic devices is dynamically reconfigurable and modifiable by any one of: a customer, a manufacturer, a retailer, a vendor, and a system administrator.
